(19) United States
(12) Patent Application Publication
(10) Pub. No.: US 2019/0333095 A1
(43) Pub. Date: Oct. 31, 2019

(54) BULK ACTION ASSET MANAGEMENT

(71) Applicant: Adobe Inc., San Jose, CA (US)

(72) Inventors: Frank Passantino, San Mateo, CA (US); Kai Haas, San Mateo, CA (US)

(21) Appl. No.: 15/994,857

(22) Filed: May 31, 2018

Related U.S. Application Data
(60) Provisional application No. 62/664,141, filed on Apr. 28, 2018.

(51) Int. Cl. G06Q 30/02

(52) U.S. Cl. CPC G06Q 30/0246; G06Q 30/0204; G06Q 30/0276

(57) ABSTRACT

A bulk action management system provides a user interface to enable a user to select customizable content objects of different object types and an action to perform on the customizable content objects. The bulk action asset management system determines an object type for each of the selected customizable content objects, with each of the object types being associated with a set of application programming interfaces for that object type. For each of the selected customizable content objects, the bulk action asset management system selects an appropriate application programming interface, based on the object type of the selected customizable content object and the action to be performed, and calls the appropriate application programming interface to perform the action to update the selected customizable content object.

### CLAIM OF PRIORITY

This application claims priority to U.S. Provisional Application No. 62/664,141, filed Apr. 28, 2018, entitled “Bulk Action Asset Management,” which is hereby incorporated by reference in its entirety.

### TECHNICAL FIELD

Examples described herein relate to software as a service automation, and more specifically, to a system and method for bulk action asset management.

### BACKGROUND

Marketing automation is a category of technology that allows companies to streamline, automate, and measure marketing tasks and workflows so they can increase operational efficiency and grow revenue faster. Marketing automation helps marketers streamline their lead generation, segmentation, lead nurturing and lead scoring, customer lifecycle marketing, cross-sell and up-sell, customer retention, and marketing return on investment measurement. It allows marketers to integrate marketing initiatives and keep track of leads as they progress through the marketing funnel.

### BRIEF DESCRIPTION OF THE DRAWINGS

FIG. 1 illustrates an example automation management system that manages bulk action asset management, in accordance with some aspects.

FIG. 2 describes an example method of bulk action asset management, in accordance with some aspects.

FIG. 3 illustrates example computer systems for an automation management system in communication with other networked systems.

FIG. 4 illustrates a computer system upon which aspects described herein may be implemented.

FIGS. 5A-D illustrate example user interfaces for a bulk action asset management system.

### DETAILED DESCRIPTION

According to examples, an automation management system is provided for enabling users to activate, deactivate, delete, or unschedule marketing program assets of different types in bulk in a single workflow.

Among other advantages, bulk action asset management reduces wait times for users and processing times for the automation management system. The bulk action asset management system provides a user interface with assets tabs with an action grid to choose multiple assets and approve the assets together, greatly increasing workflow speed. The system also allows users to choose different asset types and approve/enable them with a single action, even when a similar operation performed on different types of assets need to be handled differently. In one aspect, the bulk action asset management system implements a bulk action application programming interface (API). When a user interacts with a user interface to activate, deactivate, delete, or unschedule multiple assets at once, the bulk action asset management system can perform API calls for each of the assets. As a result, the bulk action asset management system can quickly and efficiently manage assets of varying types through a single user interface and workflow process.

In addition, the bulk action asset management system can enable or disable all assets in a marketing program together, which can prevent situations where a program is partially functional or half-finished work is approved when multiple users in an organization are editing content at the same time.

In one aspect, the bulk action asset management system provides a user interface to enable a user to select (i) a plurality of customizable content objects of different object types, and (ii) an action to perform on the plurality of customizable content objects. The bulk action asset management system determines an object type for each of the selected customizable content objects, with each of the object types being associated with a set of application programming interfaces for that object type.

For each of the selected customizable content objects, the bulk action asset management system selects an appropriate application programming interface based on the object type of the selected customizable content object and the action to be performed.

For each of the selected customizable content objects, the bulk action asset management system calls the appropriate application programming interface to perform the action to update the selected customizable content object.

In some aspects, the action includes activating each of the customizable content objects. In one example, activating a customizable content object makes it available for the user or other users to access through one or more additional user interfaces associated with the bulk action asset management system.

In further aspects, the action includes causing each of the customizable content objects to be published using a publication medium that is specific to the object type of each of the customizable content objects.

In some aspects, the customizable content objects are assets belonging to a marketing campaign. The assets can include emails, email templates, webpages, forms, lists, and automated logic campaigns. The assets can also be stored in a marketing automation platform.

One or more aspects described herein provide that methods, techniques and actions performed by a computing device are performed programmatically, or as a computer-implemented method. Programmatically means through the use of code, or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Furthermore, one or more aspects described herein may be implemented through the use of instructions that are executable by one or more processors. These instructions may be carried on a computer-readable medium. Machines shown or described with figures below provide examples of processing resources and computer-readable media on which instructions for implementing some aspects can be carried and/or executed. In particular, the numerous machines shown in some examples include processor(s) and various forms of memory for holding data and instructions. Examples of computer-readable media include permanent memory storage devices, such as hard drives on personal computers or servers. Other examples of computer storage media include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

System Overview

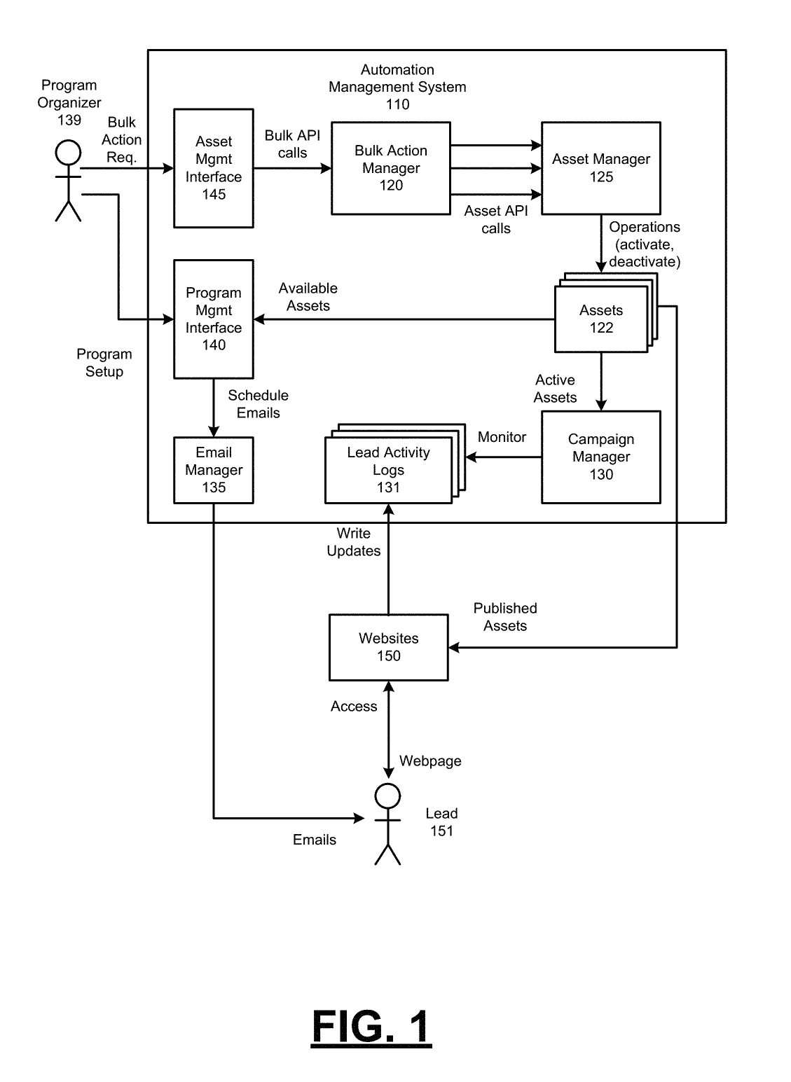

FIG. 1 illustrates an example automation management system that manages marketing programs and their assets, in accordance with some aspects. The automation management system 110 allows program organizers 139 to create a marketing campaign and campaign assets and apply one or more actions to the assets, such as activating, deactivating, deleting, and unscheduling assets within a single workflow. In some aspects, the automation management system 110 includes a bulk action manager 120, asset manager 125, assets 122, a campaign manager 130, lead activity logs 131, email manager 135, a program management interface 140, and an asset management interface 145. In addition, an example automation management system 110 can include other components and functionality not illustrated for the sake of simplicity.

In some aspects, the automation management system 110 represents a software platform implementing technologies for marketing departments and organizations to more effectively reach consumers across multiple channels online (such as email, social media, websites, etc.) and automate repetitive tasks. Marketing departments, consultants, and employees benefit by specifying criteria and outcomes for tasks and processes that are interpreted, stored, and executed by software, which increases efficiency and reduces human error. Marketing automation refers to a broad range of automation and analytical tools for marketing that can be used as a hosted or web-based solution. Accordingly, in some aspects, the automation management system 110 does not require software installation. Instead, users such as program organizers 139 can access the automation management system 110 over a network through web-based interfaces such as the program management interface 140 in order to plan, coordinate, manage, and measure their marketing initiatives.

As used herein, a program represents a single one of these marketing initiatives. In some implementations, programs act as organizational containers filled with two main types of assets that enable the program to work: customizable content (emails, webpages, forms, images, etc.) and campaigns—the automated marketing logic that tells the program what to do.

A program is the mechanism by which a marketer organizes all their different types of marketing efforts from one central location. One example of a program is an email blast. A lead takes multiple actions/activities related to a given program that the campaign manager 130 can associate with the program. This is known as lead progression. An example progression of an email blast program would record when a lead is sent an email, when the lead opens the email, and whether they clicked through a link in the email. Besides email programs, the automation management system 110 supports programs such as event programs and engagement programs. Event programs help coordinate, facilitate, and track live and online events, that is, anything that has attendees at a specific date and time. Program organizers 139 can build events utilizing a program-level calendar through the program management interface 140, sync with mobile applications, and integrate with third party event platforms. Engagement programs utilize drip nurturing strategies to engage leads, communicate with leads on a periodic schedule, and send out content based on priority and availability. Programs can also be used to build out initiatives focused on list purchases, online advertising, social media, web promotions, etc.

Campaigns are created to serve a specific purpose and specific goal within a program. An example of a campaign is a script to narrow down a group of leads and send them an email blast, or to notify a sales representative for follow up if a lead clicks through a link within the email blast program. The first is an example of a filter campaign, which searches for leads based on specific attributes and can be scheduled to run at specific dates and times. The second is an example of a trigger campaign that listens for lead behavior and fires when events occur. Both of these types of campaigns are example smart campaign assets that a program organizer 139 can create through the program management interface 140 or manage through the asset management interface 145.

Leads generally refer to entities, such as people or organizations, who may have an interest or purpose in a particular source (e.g., another company, firm, etc.) of product or service. As described with some examples, leads can be represented by corresponding records that contain information about their subjects, such as contact information (e.g., email address, phone number, address) and/or profile information (e.g., past purchases). In the context of marketing campaigns, records that identify leas can be acquired and/or developed. For example, new leads can be identified by tracking website visits, as well as by conducting online or traditional advertisements, webinars, and other marketing campaigns. Depending on the reach of these marketing campaigns, millions of leads may be generated through different marketing channels. The management of this large body of leads—to keep track of them, to identify the potential customers to nurture, to identify the high-quality ones as opportunities, among other activities—is time-consuming and error-prone.

An automation management system 110 helps a marketer manage this large quantity of leads. Marketing activities associated with the leads include marketing actions as well as actions taken by sales staff, such as by sales emails, phone calls, online meeting, demonstrations, customer visits, etc. They also include activities originated by the leads themselves, such as web site visits and form fill-outs, both before and after the leads reach the opportunity stage.

In some aspects, individual leads are associated with corresponding records that detail information about the leads. forms that leads fill out, details recorded during phone calls, and online interactions are provided to the automation management system 110. For example, a lead can fill out a form on a website 150, which submits the form back to the automation management system 110. In other aspects, data are first entered into other databases such as customer relationship management (CRM) systems and then imported into the automation management system 110 through one or more interfaces (not illustrated).

The automation management system 110 can store a database of leads with information about each lead. The database can include fields that identify and define the lead such as their name, email address, age, gender, city, company name, job title, industry, lead source, etc. The database can also include lead activity logs 131, which are records of lead interactions with various marketing activities and records of lead interests, brand preferences, etc.

Targeted lists (also referred to as smart lists or filtered lists) allow users such as program organizers 139 to use one or more criteria as filters in order to find specific groups of people and organize a database of leads based on designated characteristics. For example, a program organizer 139 can generate a targeted list that includes all leads in the database who have visited the pricing page on their business's website. Since the automation management system 110 continually updates each targeted list, the program organizer 139 or anyone else with permission can access the targeted list again at a different time for current data about who is visiting that pricing page.

In some aspects, the automation management system 110 is in communication with associated websites 150 that a lead 151 accesses. The websites 150 can store, process, and deliver webpages to clients, such as a web browser on a computing device belonging to the lead 151. The communication between the user computing device and web server 120 can take place using the Hypertext Transfer Protocol (HTTP). Pages delivered include Hypertext Markup Language (HTML) documents, which may contain images, style sheets, and scripts in addition to text content.

In one example, the program organizer 139 accesses the program management interface 140 to create an event program for a dinner event. The program organizer 139 can set various parameters and program settings for the program, including a date and time for the dinner and a description. The program organizer 139 would like to allow people to RSVP for the dinner so they create a form through the program management interface 140 that requests a name and contact details for anyone wishing to attend. The program organizer 139 then creates a landing page through the program management interface 140 for the dinner. The program organizer 139 can generate the landing page using a template system that the program management interface 140 provides and can include further details regarding the dinner for lead 151 to read. With the landing page created, the program organizer 139 can insert the form into the landing page so that visitors 151 to the landing page can fill out the form to RSVP to the dinner. The program organizer 139 can then distribute a link to the landing page, for example through emails, a link on another web page, or social media postings.

Thus, when a visitor lead follows the link to the landing page, their web browser contacts the website 150 with a request. The web server 120 can include an asset retriever 122 component to fetch the landing page 115, which includes form 116. The web server 120 can then provide the landing page, which includes the form, to the lead 151. If the lead 151 fills out the form to register for the dinner, code embedded in the landing page associated with the form can trigger the creation of an event on the lead activity log 131 for the lead 151 called ‘filled out form’ with the URL in the activity details. The campaign manager 130 actively listens for this event to occur on the activity log, at which point a series of actions are performed as defined in the trigger campaign. For example, the trigger campaign can contain instructions to the campaign manager 130 to add the lead 151 to a guest list, send them an email confirmation, and redirect their web browser to a ‘thank you’ page, among other actions.

Each marketing program consists of many different types of assets: emails that are sent out to people, webpages linked in the emails, forms for people to fill out on the webpages, and the listeners and operational workflows that happen programmatically as well. To avoid unfinished or unapproved assets from being inadvertently shown to leads 151, the program management interface 140 can require that assets be approved or activated in order to be used in the program. For example, when a program organizer 139 creates a new email to be sent as part of a marketing event, the program organizer 139 or another member of their company/entity must approve the email through the asset management interface 145 before the program management interface 140 allows the email to be sent. In another example, when a program organizer 139 creates a landing page asset for the event, that landing page must be published to a website 150 before a lead 151 can access it.

Depending on the type of asset, the activation or approval process triggers a different back-end workflow with an asset manager 125. Emails or email templates are flagged as available to be sent through the email manager 135, webpages are published on the web and flagged as available to be included in programs (e.g., as landing pages, fallback pages, etc.), forms are flagged as available to be added to webpages and used by leads 151, and trigger campaigns are flagged as available and active for the campaign manager 130 to begin listening for the appropriate triggers.

In some aspects, each type of asset may use different, asset-specific terminology to reference whether the asset is in an “active” state. For example, assets may be turned on, listening, activated, approved, published, or available to be accessed, any of which can be considered an “active” state. In contrast to being active, assets can also be in a “deactivated” state. For example, deactivated landing pages are not published or accessible. Emails that aren't approved can't be sent. Campaigns that are not turned on are not listening to forms.

In some aspects, program organizers 139 can use the asset management interface 145 to go through a list of marketing program assets and activate, deactivate, delete, or unschedule specific assets such as emails, webpages, forms, trigger campaigns, and batch campaigns. Rather than performing an action on assets individually, the program organizer 139 can select any number of assets within a program or folder of programs and apply the action to each of the assets. A bulk action manager 120 enables the program organizer 139 to activate, deactivate, or delete all these assets at once instead of manually one by one.

In one aspect, the asset management interface 145 implements a bulk action application programming interface (API). When a program organizer 139 interacts with the asset management interface 145 to activate, deactivate, delete, or unschedule multiple assets at once, the asset management interface 145 can perform a bulk action API call to a bulk action manager 120. In some implementations, each bulk action API call has a limit on the number of assets for performance reasons (e.g., ten assets at a time), and the asset management interface 145 can separate a request from the program organizer into batches of assets. For example, if the program organizer 139 selects twenty-five assets to activate at once, the asset management interface 145 can perform an API call to the bulk action manager 120 for the first ten assets. Then, once the bulk action manager 120 indicates that those assets have been processed, the asset management interface 145 can perform another API call for the next ten assets, then the final five.

When the bulk action manager 120 receives a bulk API call from the asset management interface 145, the bulk action manager 120 can identify the specific assets and the requested operation from the call. The bulk action manager 120 can also determine the type of each asset based on the ID of the asset. Based on the type of asset, the bulk action manager 120 performs separate asset API calls to an asset manager 125. In some aspects, the bulk action manager 120 implements a separate API for each type of asset and each action. Thus, for example, the bulk action manager 120 uses different APIs for activating an email and activating a webpage for use with the automation management system 110.

Based on the API used, the asset manager 125 performs the necessary operations on the assets 122 in order to set them to activated or deactivated, or to delete the asset or unschedule a batch campaign.

Among other operations on different types of assets, if the deactivated asset is a trigger campaign such as a program script, the asset manager 125 can deregister any event listeners for the program script, thereby deactivating the trigger campaign. As a result, when future leads 151 submit the form, the program script will no longer be listening and the program script will not execute. If the deactivated asset is a landing page or other web-based asset, the asset manager 125 sends a set of deactivate commands to the website 150 to update the server configuration so that future requests for the landing page are redirected to a fallback page.

When a program organizer 139 access the program management interface 140 to create a program using existing assets, the program management interface 140 can display only the use of assets that have been set to the activated state by the asset manager 125. For example, if a program organizer 139 wants to choose a landing page for an event, the program management interface 140 can display a list of available landing pages to be used, but this list only includes landing pages that have been activated.

In some aspects, when the program organizer 139 requests a bulk action on the asset management interface 145, the asset management interface 145 can continually update a percentage of assets updated on the user interface and also save a log of failures and reasons for failure to display to the program organizer 139.

Methodology

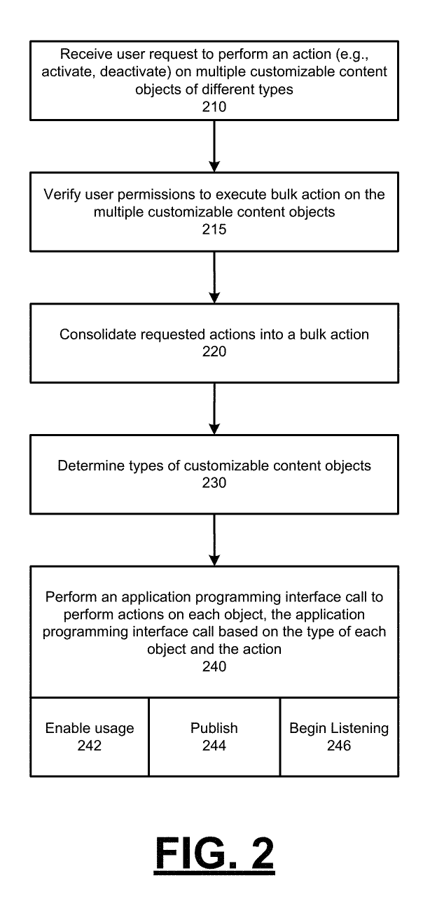

FIG. 2 describes an example method of bulk action asset management, in accordance with some aspects. While operations of these methods are described below as being performed by specific components, modules or systems of automation management system 110, it will be appreciated that these operations need not necessarily be performed by the specific components identified, and could be performed by a variety of components and modules, potentially distributed over a number of machines. Accordingly, references may be made to elements of automation management system 110 for the purpose of illustrating suitable components or elements for performing a step or sub step being described. Alternatively, at least certain ones of the variety of components and modules described in automation management system 110 can be arranged within a single hardware, software, or firmware component. It will also be appreciated that some of the steps of this method may be performed in parallel or in a different order than illustrated.

With reference to FIG. 2, in some aspects, an automation management system provides a user interface through which the automation management system receives a user request to perform an action (e.g., activate, deactivate) on multiple customizable content objects, such as marketing campaign assets (210).

In some aspects, the automation management system can verify user or account permissions for the user to determine whether the user has permission to execute the action on the selected customizable content objects (215). In some examples, the user interface can display an error message if the user does not have permission to execute the action on one or more of the objects.

The automation management system can consolidate the requested actions into a bulk action (220) and determine the type of each customizable content object (230). Based on the type of customizable content object and the action requested, the automation management system can select an appropriate application programming interface and perform an application programming interface call to perform the action (240). Examples of activation operations that can be performed on assets include enabling usage of the asset (242), publishing the asset on a webpage (244), and to begin listening for event triggers (246).

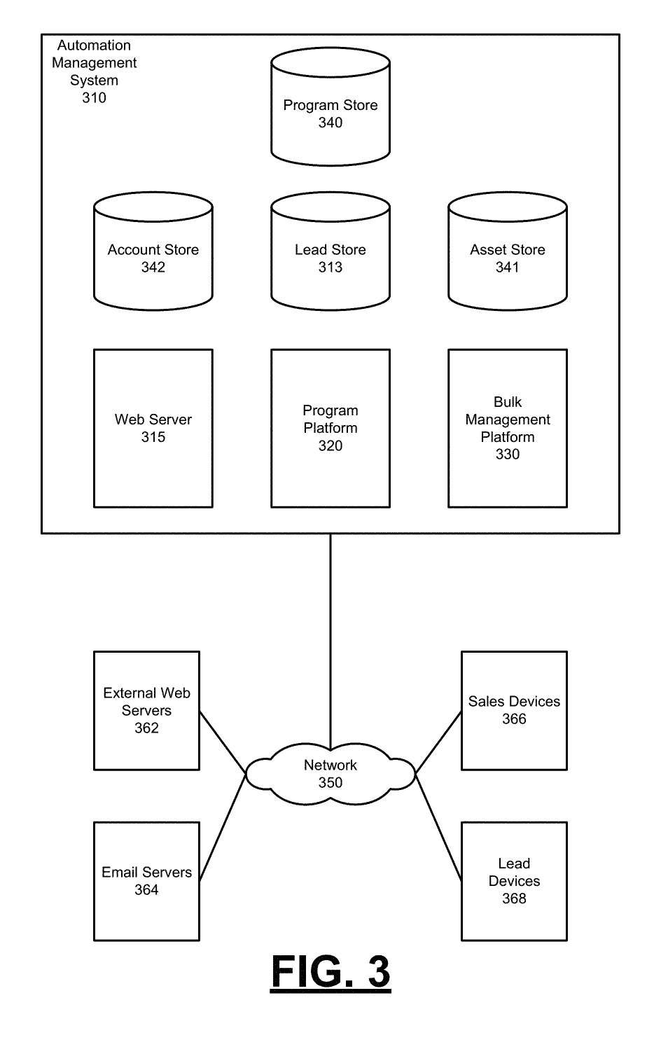

FIG. 3 illustrates example computer systems for an automation management system 310 in communication with other networked systems such as external web servers 362, email servers 364, marketer devices 366, and lead mobile devices 368.

User devices, including marketer devices 366 and lead mobile devices 368, comprise one or more computing devices that can receive user input and can transmit and receive data via the network 350. In one aspect, a user device is a conventional computer system executing, for example, a Microsoft Windows-compatible operating system (OS), Apple OS X, and/or a Linux distribution. In another aspect, the user device can be a device having computer functionality, such as a personal digital assistant (PDA), mobile telephone, smart-phone, etc. The user device is configured to communicate via network 350. The user device can execute an application, for example, a browser application that allows a user of the user device to interact with the automation management system 310. In another aspect, the user device interacts with the automation management system 310 through an application programming interface (API) that runs on the native operating system of the user device, such as iOS and ANDROID.

In one aspect, the network 350 uses standard communications technologies and protocols. Thus, the network 350 can include links using technologies such as Ethernet, 802.11, worldwide interoperability for microwave access (WiMAX), 3G, 4G, CDMA, digital subscriber line (DSL), etc. Similarly, the networking protocols used on the network 350 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 350 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

The web server 315 links the automation management system 310 via the network 350 to one or more user devices; the web server 315 serves web pages, as well as other web-related content, such as Java, Flash, XML, and so forth. The web server 315 may provide the functionality of receiving and routing messages between the automation management system 310 and the user devices, for example, instant messages, queued messages (e.g., email), text and SMS (short message service) messages, or messages sent using any other suitable messaging technique. The user can send a request to the web server 315 to upload information, for example, images or videos that are stored in an asset store 341. In addition, the user can enter marketing program data into the automation management system 310 through the web server 315 to be stored in a program store 340. Asset store 341, program store 340, and other stores can be implemented as one or more relational databases, collections of structured files such as XML files, flat plain text files, or any other method of data storage. In some aspects, automation management system 310 is a software as a service (SaaS) platform that users access through the web server 315. Additionally, the web server 315 may provide API functionality to send data directly to native user device operating systems, including iOS, Android, webOS, and Windows, among others.

A program platform 320 implements functionality to receive and store information and configuration settings for marketing programs. In addition, the program platform 320 can listen for events generated from web server 315 and execute program scripts associated with smart campaigns.

In one aspect, information may be manually inputted into the automation management system 310 through a user interface. In another aspect, information about marketing activities may be gathered by the automation management system 310 through application programming interface (API) calls to external web servers 362. In a further aspect, the automation management system 310 can use a SOAP (Simple Object Access Protocol) or REST (REpresentation State Transfer) API to receive the information. In a further aspect, web pages served by external web servers 362 can include programming (e.g., javascript code embedded in the HTML) that transmits the information back to the automation management system 310. Email servers 364 can be configured to transmit information about lead interactions with email messages back to the automation management system 310. Lead details and relevant data and metadata regarding the leads are stored in a lead store 313 with the automation management system 310.

In some aspects, the bulk management platform 330 provides a user interface to users of the automation management system 310 for manually activating, deactivating, deleting, or unscheduling assets in bulk.

Computer System

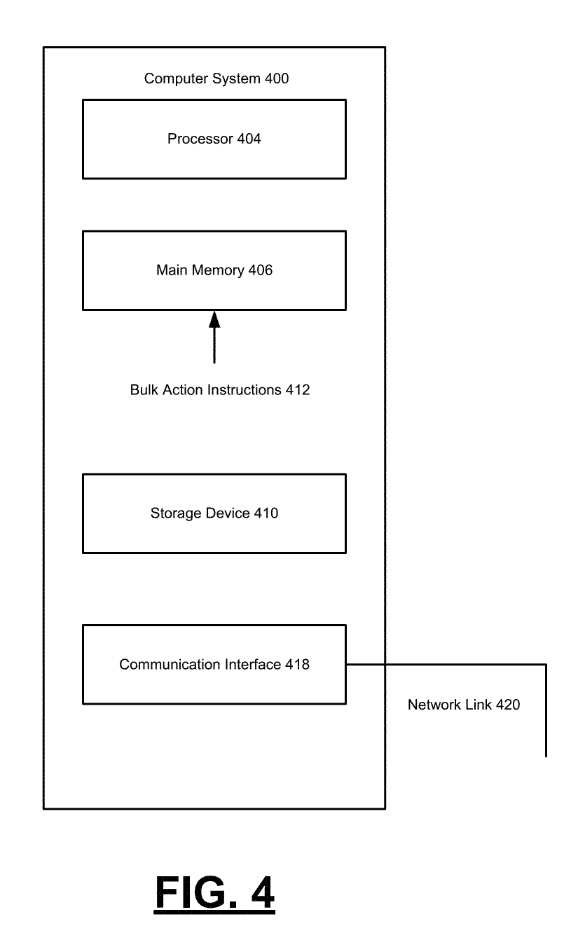

FIG. 4 is a block diagram that illustrates a computer system upon which aspects described herein may be implemented. For example, in the context of FIG. 1, automation management system 110 may be implemented using one or more servers such as described by FIG. 4.

In an aspect, computer system 400 includes processor 404, memory 406 (including non-transitory memory), storage device 410, and communication interface 418. Computer system 400 includes at least one processor 404 for processing information. Computer system 400 also includes the main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 may also include a read only memory (ROM) or other static storage device for storing static information and instructions for processor 404. The storage device 410, such as a magnetic disk or optical disk, is provided for storing information and instructions such as bulk action instructions 412. The communication interface 418 may enable the computer system 400 to communicate with one or more networks through use of the network link 420 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Examples described herein are related to the use of computer system 400 for implementing the techniques described herein. According to one aspect, those techniques are performed by computer system 400 in response to processor 404 executing one or more sequences of one or more instructions contained in main memory 406. Such instructions (e.g., bulk action instructions 412) may be read into main memory 406 from another machine-readable medium, such as storage device 410. Execution of the sequences of instructions contained in main memory 406 causes processor 404 to perform the process steps described herein. In alternative aspects, hard-wired circuitry may be used in place of or in combination with software instructions to implement aspects described herein. Thus, aspects described are not limited to any specific combination of hardware circuitry and software.

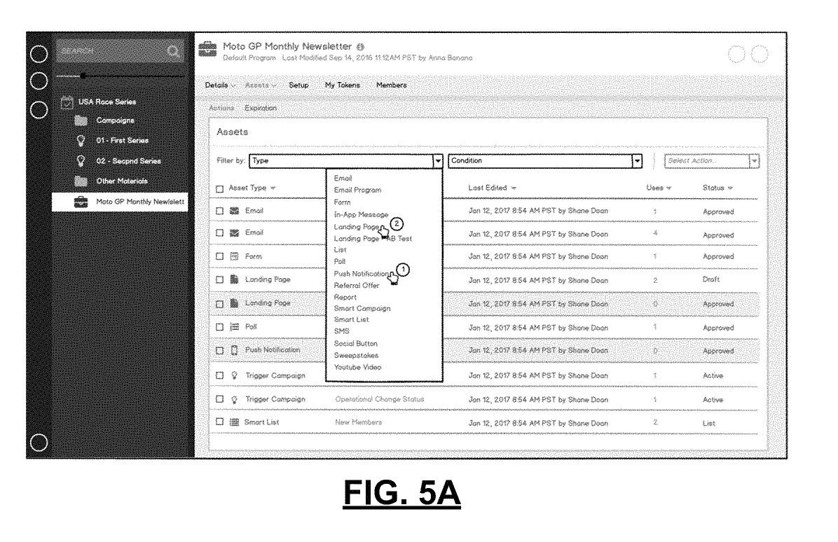

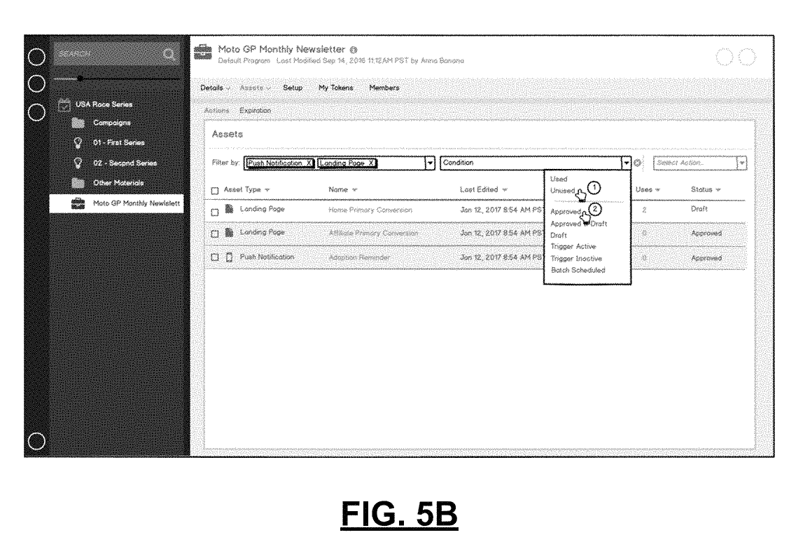

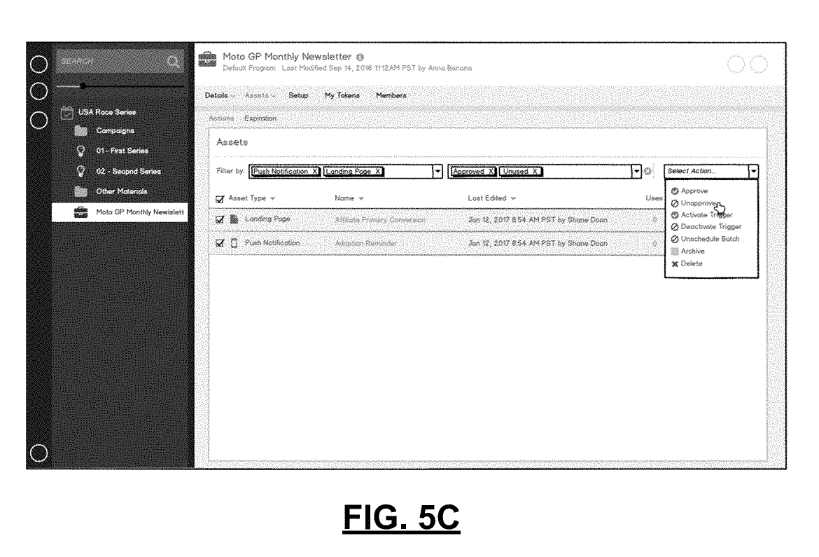

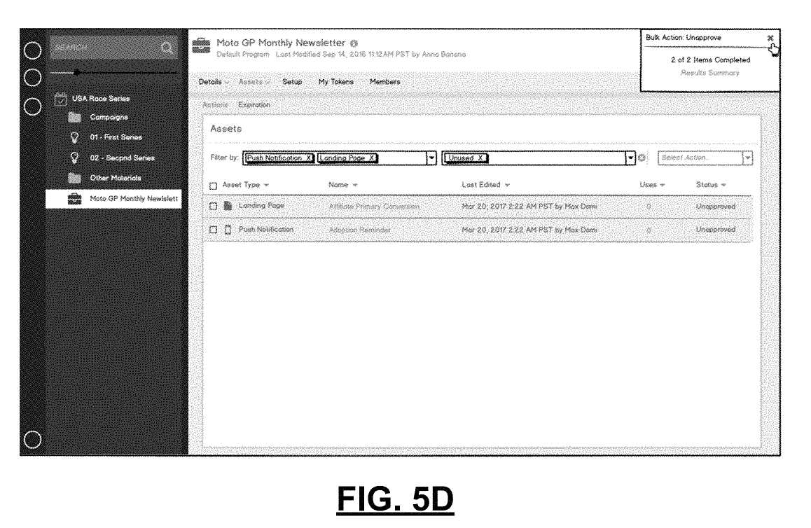

FIGS. 5A-D illustrate example user interfaces for a bulk action asset management system. The user interfaces illustrated display a list of assets for the “Moto GP Monthly Newsletter” program in an example USA Race Series marketing program. As shown, each asset in the list is displayed with its asset type, name, a date when the asset was last edited, a number of times that asset has been used, and the asset's current status.

As illustrated in FIG. 5A, the user interface enables a user to filter the list of assets by object type. Thus, when a user selects the “Filter by:” dropdown box, the user can select which types of assets to display in the list.

As illustrated in FIG. 5B, the user interface enables a user to filter the list of assets by condition. For example, the user can filter the assets by which assets are used or unused, approved/active, inactive, in draft form, or scheduled.

As illustrated in FIG. 5C, the user interface enables a user to select check boxes for any number of assets of varying types and select an action from a dropdown box to apply to the selected assets. For example, the user can select a landing page and a push notification that are approved and unused and select “Unapprove” from the dropdown box. As a result, the bulk action manager can set the landing page and the push notification to an unapproved, or deactivated, state.

As illustrated in FIG. 5D, after performing a selected action, the user interface can display a basic results summary to the user with a link to a page with more details. In this example, both items were successfully unapproved.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A computer system for bulk action management comprising:
one or more processors; and
one or more memory resources storing instructions that, when executed by the one or more processors, cause the computer system to perform operations including:
providing a user interface to enable a user to select (i) a plurality of customizable content objects of different object types, and (ii) an action to perform on the plurality of customizable content objects;
determining an object type of each of the selected customizable content objects, wherein each of the object types are associated with a set of application programming interfaces for that object type; and
for each of the selected customizable content objects:
selecting an appropriate application programming interface based on the object type of the selected customizable content object and the action to be performed; and
calling the appropriate application programming interface to perform the action to update the selected customizable content object.

2. The computer system of claim 1, wherein the action includes activating each of the customizable content objects.

3. The computer system of claim 2, wherein activating a customizable content object makes it available for the user or other users to access through one or more additional user interfaces associated with the computer system.

4. The computer system of claim 1, wherein the action includes causing each of the customizable content objects to be published using a publication medium that is specific to the object type of each of the customizable content objects.

5. The computer system of claim 1, wherein the customizable content objects are assets belonging to a marketing campaign.

6. The computer system of claim 5, wherein the assets include emails, email templates, webpages, forms, lists, and automated logic campaigns.

7. The computer system of claim 5, wherein the assets are stored in a marketing automation platform.

8. A method of bulk action management, the method being implemented by one or more processors and comprising:
providing a user interface to enable a user to select (i) a plurality of customizable content objects of different object types, and (ii) an action to perform on the plurality of customizable content objects;
determining an object type of each of the selected customizable content objects, wherein each of the object types are associated with a set of application programming interfaces for that object type; and
for each of the selected customizable content objects:
selecting an appropriate application programming interface based on the object type of the selected customizable content object and the action to be performed; and
calling the appropriate application programming interface to perform the action to update the selected customizable content object.

9. The method of claim 8, wherein the action includes activating each of the customizable content objects.

10. The method of claim 9, wherein activating a customizable content object makes it available for the user or other users to access through one or more additional user interfaces associated with a computer system.

11. The method of claim 8, wherein the action includes causing each of the customizable content objects to be published using a publication medium that is specific to the object type of each of the customizable content objects.

12. The method of claim 8, wherein the customizable content objects are assets belonging to a marketing campaign.

13. The method of claim 12, wherein the assets include emails, email templates, webpages, forms, lists, and automated logic campaigns.

14. The method of claim 12, wherein the assets are stored in a marketing automation platform.

15. A non-transitory computer-readable medium that stores instructions, executable by one or more processors, to cause the one or more processors to perform operations that comprise:
providing a user interface to enable a user to select (i) a plurality of customizable content objects of different object types, and (ii) an action to perform on the plurality of customizable content objects;
determining an object type of each of the selected customizable content objects, wherein each of the object types are associated with a set of application programming interfaces for that object type; and
for each of the selected customizable content objects:
selecting an appropriate application programming interface based on the object type of the selected customizable content object and the action to be performed; and
calling the appropriate application programming interface to perform the action to update the selected customizable content object.

16. The non-transitory computer-readable medium of claim 15, wherein the action includes activating each of the customizable content objects.

17. The non-transitory computer-readable medium of claim 16, wherein activating a customizable content object makes it available for the user or other users to access through one or more additional user interfaces associated with a computer system.

18. The non-transitory computer-readable medium of claim 15, wherein the action includes causing each of the customizable content objects to be published using a publication medium that is specific to the object type of each of the customizable content objects.

19. The non-transitory computer-readable medium of claim 15, wherein the customizable content objects are assets belonging to a marketing campaign.

20. The non-transitory computer-readable medium of claim 19, wherein the assets include emails, email templates, webpages, forms, lists, and automated logic campaigns.
